(19) United States
(12) Patent Application Publication
(10) Pub. No.: US 2003/0110069 A1
(43) Pub. Date: Jun. 12, 2003

(54) Workforce planning apparatus for calculating number of workers to be a allocated

(75) Inventor: Shigeo Nishizono, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/247,342

(22) Filed: Sep. 20, 2002

(30) Foreign Application Priority Data
Nov. 20, 2001 (JP) 2001-354181(P)

(51) Int. Cl. G06F 17/60

(52) U.S. Cl. 705/8

(57) ABSTRACT

A number of workers decision table creating unit in a workforce planning apparatus reads necessary information from a master file to create a number of workers decision table. A number of workers calculating unit uses the created, number of workers decision table to calculate a planned number of workers to be allocated for each operation process in a factory. A determination unit compares operation group information in an operation group storing file with the calculated, planned number of workers to determine whether each operation process can be carried out with the number of workers in the operation group. Therefore, it is possible to calculate the number of workers to be allocated for each operation process accurately, in production control in a factory with a job shop line.

### BACKGROUND OF THE INVENTION

1. Field of the Invention

The present invention relates to a workforce planning apparatus and more specifically to a workforce planning apparatus that calculates a planned number of workers to be allocated for each operation process.

2. Description of the Background Art

In a factory manufacturing products, operations are performed based on production control. Production control as used herein refers to a management procedure for completing products by a scheduled date by rationally combining facilities in a factory, raw materials for products and workers operating in the factory based on production planning. In the production control, it is particularly important to predict the number of workers to be allocated for each operation process in a factory, because the operations in the factory are effected by the workers.

Production lines in a factory include a flow shop line and a job shop line.

FIG. 5 schematically shows a configuration of a flow shop line.

Referring to FIG. 5, in a flow shop line, product A is produced in a plurality of operations A1, A2 and A3 connected in series. Similarly, product B is produced in operations B1, B2 and B3 connected in series, and product C is produced in operations C1, C2 and C3 connected in series. Here, operations A1, B1 and C1 use the same operation apparatus 100. Similarly, operations A2, B2 and C2 use the same operation apparatus 200, and operations A3, B3 and C3 use the same operation apparatus 300. A representative example of a flow shop line includes flow production using a conveyor.

FIG. 6 schematically shows a configuration of a job shop line.

Referring to FIG. 6, a flow shop line has the same order of using apparatuses and the same number of operations for operation apparatuses for each product, whereas a job shop line uses an arbitrary operation apparatus in an arbitrary order for each product. Furthermore, the number of operations may vary among products. For example, as to product A, operation apparatus 300 is used in operation A1, thereafter operation apparatus 100 is used in operation A2 and finally operation apparatus 200 is used in operation A3. On the other hand, as to product B, operation apparatus 100 is used in operation B1, operation apparatus 300 is used in operation B2, and operation apparatus 200 is used in operation B3. Furthermore, as to product C, operation apparatus 200 is used in operation C1 and operation apparatus 300 is used in operation C2.

A production control method in the flow shop line shown in FIG. 5 is described, for example, in Japanese Patent Laying-Open Nos. 10-261122 and 8-287127.

As described above, the flow shop line has the same order of using apparatuses and the same number of operations for each product. Therefore, the number of workers to be allocated through a production line for a product can be predicted relatively accurately.

In the job shop line, however, the order of using apparatuses and the number of operations vary among products. As a result, the same method of predicting the number of workers as the conventional flow shop line would result in an undesirable precision in a predicted value.

Moreover, difficulty levels in skill in carrying out operations vary among operations. Therefore, even if the number of workers is predicted and a worker is then allocated in an operation, that prediction may be found in vain unless the worker has skill sufficient to perform that operation.

### SUMMARY OF THE INVENTION

An object of the present invention is to provide a workforce planning apparatus that accurately calculates the number of workers to be allocated in each operation process.

A workforce planning apparatus in accordance with the present invention includes an available apparatus information storing unit, a planned production volume storing unit, a production condition storing unit, a number of workers decision table creating unit, and a number of workers calculating unit. The available apparatus information storing unit stores information on a plurality of apparatuses for use for each of operation processes. The planned production volume storing unit stores a planned production volume for a prescribed period. The production condition storing unit stores a production condition through an operation process. The number of workers decision table creating unit extracts information from the available apparatus information storing unit, the planned production volume storing unit and the production condition storing unit, and records the extracted information in a number of workers decision table. The number of workers calculating unit calculates a planned number of workers to be allocated for each of operation processes using the information in the number of workers decision table.

The workforce planning apparatus in accordance with the present invention calculates man-number for each operation process. Furthermore, it is determined whether the number of workers in an actual operation group satisfies the calculated man-number, in consideration of skill level of each worker. Thus, the number of workers to be allocated for each operation process can be calculated accurately in production control a factory with a job shop line.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram showing a configuration of the workforce planning apparatus in accordance with an embodiment of the present invention.

FIG. 2 is a schematic block diagram showing a configuration of a computer.

FIG. 3 is a flow chart illustrating an operation of the workforce planning apparatus in accordance with an embodiment of the present invention.

FIG. 4 is a graph illustrating the relation between the production volume and the total work-hour in a factory, calculated by the workforce planning apparatus of the present invention.

FIG. 5 is a diagram schematically showing a configuration of a flow shop line.

FIG. 6 is a diagram schematically showing a configuration of a job shop line.

### DESCRIPTION OF THE PREFERRED EMBODIMENTS

In the followings, an embodiment of the present invention will be described in detail with reference to the figures. It is noted that in the figures the same or corresponding parts will be denoted with the same reference characters and description thereof will not be repeated.

[Configuration of Workforce Planning Apparatus]

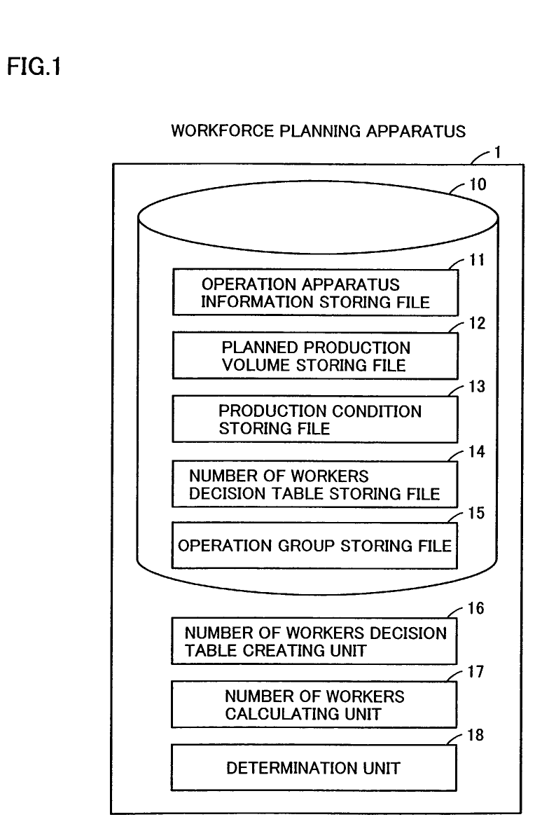

FIG. 1 is a schematic block diagram showing a configuration of the workforce planning apparatus in accordance with an embodiment of the present invention.

Referring to FIG. 1, a workforce planning apparatus 1 includes a master file 10, a number of workers decision table creating unit 16, a number of workers calculating unit 17, and a determination unit 18.

Master file 10 includes an operation apparatus information storing file 11, a planned production volume storing file 12, a production condition storing file 13, a number of workers decision table storing file 14, and an operation group storing file 15.

Operation apparatus information storing file 11 stores information such as the installation number, the capacity and the like of an operation apparatus installed in a factory, as a table shown in Table 1.

TABLE 1

| | | | capacity |
|---|---|---|---|
| apparatus name | installation number | running number | (lot/running) |
| AA1 | 5 | 3 | 0.5 |
| AB1 | 2 | 1 | 0.35 |
| BB1 | 4 | 4 | 0.3 |
| BB3 | 10 | 7 | 0.6 |
| BC5 | 1 | 1 | 0.25 |
| . . . | . . . | . . . | . . . |
| . . . | . . . | . . . | . . . |
| . . . | . . . | . . . | . . . |

Referring to Table 1, the table stored in operation apparatus information storing file 11 includes an apparatus name field, an installation number field, a running number field and a capacity field.

The name of the apparatus installed in the factory is recorded in the apparatus name field. The number of the operation apparatuses installed in the factory, having their names in the apparatus name fields is recorded in the installation number field. The number of those operation apparatuses having their names in the apparatus name fields which are running is recorded in the running number field. The capacity for each operation apparatus having its name in the apparatus name field is recorded in the capacity field. Referring to Table 1, for example, in case of an apparatus having the name “AA1”, the number thereof installed in the factory is five, three of which are now running. The capacity for each apparatus is such that 0.5 lot of target product can be processed for each running. A lot as used herein refers to a group of the same products as a unit of producing articles.

Planned production volume storing file 12 stores a planned production volume to be attained in a prescribed period in the factory as a table shown in Table 2.

TABLE 2

| month | | | |
|---|---|---|---|
| of load | | planned production volume | planned production volume |
| calculation | | (lot/month) | (lot/day) |
| 2001 | 11 | 300 | 10 |
| | 12 | 310 | 10 |
| 2002 | 1 | 183 | 9 |
| | 2 | 280 | 10 |
| | 3 | 183 | 9 |
| | . . . | . . . | . . . |
| | . . . | . . . | . . . |
| | . . . | . . . | . . . |

Referring to table 2, a monthly planned production volume and a daily planned production volume are recorded in the table stored in planned production volunteer storing file 12. For example, in December 2001, the monthly planned production volume is 310 lots and the daily planned production volume is 10 lots.

Production condition storing file 13 stores production conditions based on human factors in production as a table shown in Table 3.

TABLE 3

| | | |
|---|---|---|
| man-hour | hour/(shift · person) | 10.5 |
| working efficiency | % | 80.0 |

Referring to Table 3, the table stored in production condition storing file 13 includes a man-hour field and a working efficiency field.

The man-hour per shift for each worker is recorded in hours in the man-hour field. Here, the man-hour is 10.5 hours/(shift·person). A shift as used herein refers to a unit of a period of time during which a worker is working in a factory. The working efficiency field shows working efficiency per shift in percent. Here, the working efficiency is 80%. Then, 20% of time per shift is used for rest, meals and the like. Empirical values accumulated in years of factory operations are input as working efficiency.

Number of workers decision table storing file 14 stores the number of workers decision table created in number of workers decision table creating unit 16. The number of workers decision table will be described later.

Operation group storing file 15 stores a plurality of operation groups working in a factory, as a table shown in Table 4. It also stores information about whether a plurality of workers constituting each operation group have the ability to carry out their respective operation processes.

TABLE 4
first group

| | | operation process details | | | | | | | | | | | | |
|---|---|---|---|---|---|---|---|---|---|---|---|---|---|---|
| | | | | | small category | | | | | | | | | |
| | | | | | | | operation | | | | | | | |
| | | | large | medium | | | time | occurrence | worker name | | | | | |
| | | | cate- | cate- | | diffi- | (min/ | frequency | GL | SL | | | | |
| ON | OAN | class | gory | gory | | culty | process) | (time/shift) | SHUTO | HAYASHI | ISHIDA | YAMAMOTO | . . . | . . . |
| oper- | 300 | variable | produc- | process- | ◯◯set | B | 11.5 | | ● | ● | ◯ | Δ | . . . | . . . |
| ation | | | tion | ing | com- | A | 1.0 | | Δ | ◯ | ◯ | Δ | . . . | . . . |
| A1 | | | process | | pletion | | | | | | | | | |
| | | | | | report | | | | | | | | | |
| | | | | | record | A | 1.0 | | Δ | ◯ | Δ | ● | . . . | . . . |
| | | | | carry- | product | C | 2.0 | | ● | ◯ | Δ | Δ | . . . | . . . |
| | | | | ing | carry in | | | | | | | | | |
| | | | | | process | | | | | | | | | |
| | | | | | product | D | 2.0 | | ● | ◯ | Δ | X | . . . | . . . |
| | | | | | carry | | | | | | | | | |
| | | | | | out of | | | | | | | | | |
| | | | | | process | | | | | | | | | |
| | | fixed | setup | change- | ◯◯ex- | F | 4.0 | 2 | ◯ | ● | Δ | Δ | . . . | . . . |
| | | | | over | change | | | | | | | | | |
| | | | | | ΔΔ | G | 3.5 | 1 | ● | X | X | X | . . . | . . . |
| | | | | | switch | | | | | | | | | |
| | | | keep | peri- | ●●check | C | 20.0 | 1 | ● | ◯ | Δ | Δ | . . . | . . . |
| | | | appa- | odic | ⋄⋄ | C | 15.0 | 1 | ● | ◯ | Δ | Δ | . . . | . . . |
| | | | ratus | inspec- | check | | | | | | | | | |
| | | | running | tion | □□ | B | 18.0 | 1 | ● | ◯ | Δ | Δ | . . . | . . . |
| | | | | | check | | | | | | | | | |
| | | | | peri- | ΔΔex- | G | 40.0 | 0.1 | ● | X | X | X | . . . | . . . |
| | | | | odic | change | | | | | | | | | |
| | | | | mainte- | ⋄⋄ex- | F | 20.0 | 0.1 | ◯ | ● | X | X | . . . | . . . |
| | | | | nance | change | | | | | | | | | |
| | | | | | □□ex- | F | 20.0 | 0.1 | ◯ | ● | X | X | . . . | . . . |
| | | | | | change | | | | | | | | | |
| | | | appa- | repair | ΔΔ | G | 50.0 | 0.5 | ● | X | X | X | . . . | . . . |
| | | | ratus | | repair | | | | | | | | | |
| | | | re- | | ⋄⋄ | G | 60.0 | 0.5 | ● | X | X | X | . . . | . . . |
| | | | | | repair | | | | | | | | | |
| | | | | | ●●repair | H | 60.0 | 0.5 | X | X | X | ◯ | . . . | . . . |
| | | | covery | | | | | | | | | | | |

Table 4 is a table showing information on a first group, among the tables stored in operation group storing file 15. Similar tables are recorded for other groups as well. Referring to Table 4, the table stored in operation group storing file 15 includes an operation name (ON) field, an operation apparatus name (OAN) field, an operation process details field and a worker name field. The name for each operation is recorded in the operation name field. In Table 4, there is recorded “operation A1”. The name of the operation apparatus for use in operation A1 is recorded in the operation apparatus name field. In Table 4, there is recorded “300”. The operation recorded in the operation name field is further categorized in detail within the operation process details field. The operation process details field includes a class field, a large category field, a medium category field and a small category field. Whether an operation process in an operation is classified as a variable operation or a fixed operation is indicated in the class field. A variable operation as used herein refers to an operation that is varied depending on a production volume of a product. A fixed operation as used herein refers to an operation that is not affected by a production volume of a product. The contents of operation processes in an operation are recorded in the large, medium and small category fields. The operation process in the large category of operation A1, for example, includes “setup operation”, “keeping apparatus running operation” and “apparatus recovery operation” as fixed operation. The operation process in the medium category of “keeping apparatus running operation” includes “periodic inspection” and “periodic maintenance”. The operation process in the small category of “periodic inspection” includes “●●check”, “⋄⋄check” and “□□check”. In this manner, an operation consists of a plurality of operation processes. Furthermore, the operation process in the small category is provided with a difficulty level field in order to indicate skill required for that operation quantitatively, and the difficulty level is recorded for each operation process in the small category. The difficulty level is sorted into eight levels from A to H based on a period necessary to learn the operation process as skill. The sorts of the difficulty level are shown in Table 5.

TABLE 5

| difficulty level | skill learning period |
|---|---|
| A | - one day |
| B | - one week |
| C | - two weeks |
| D | - one month |
| E | - three months |
| F | - six months |
| G | - one year |
| H | - one year and six months |

Difficulty level A, for example, is a skill level that can be attained in one day. Based on Table 5, the difficulty level for each operation process in the small group is decided.

The names of workers constituting the operation group are recorded in the worker name field. It is noted that “GL” above the name indicates a group leader of the operation group and “SL” indicates a sub-leader. In Table 4, worker name “SHUTO” is a group leader and “HAYASHI” is a sub-leader. Furthermore, operation time per operation process in the small category is recorded. For example, operation process “◯◯set” needs 11.5 minutes/operation process. In addition, the frequency of occurrence per shift is recorded for each operation process in the small category of the fixed operation. In operation process “◯◯exchange”, for example, the frequency of occurrence per shift is twice. The operation time and the frequency of occurrence are recorded based on empirical values according to years of track records.

A determination result of whether skill to perform each operation process in the small category is attained is further recorded in Table 4. In Table 4, “●” recorded below the worker name recorded in the worker field indicates that that worker has the skill to carry out the corresponding operation process in the small category and works as a main person in charge for carrying out that operation process. On the other hand, “◯” indicates that the worker has the skill to carry out the corresponding operation process in the small category and works as a sub-person in charge for carrying out that operation. “Δ” indicates that the worker has the skill to carry out the corresponding operation process in the small category, and “×” indicates that the worker does not have the skill to carry out the corresponding operation process in the small category. Worker name “SHUTO”, for example, does not have the skill to carry out operation “●●repair” of the operation processes in the small category in Table 4 but has the skill to carry out the other operation processes. On the other hand, worker name “HAYASHI” does not have the skill to carry out operations “ΔΔswitch”, “ΔΔexchange”, “ΔΔrepair”, “⋄⋄repair” and “●●repair” of the operation processes in the small category. Furthermore, the main person in charge for “◯◯set” is worker names “SHUTO” and “HAYASHI”, and the sub-person in charge is “ISHIDA”. The main person in charge for “⋄⋄check” is worker name “SHUTO” and the sub-person in charge is worker name “HAYASHI”.

Returning to FIG. 1, number of workers decision table creating unit 16 creates a number of workers decision table for calculating the number of workers. Number of workers calculating unit 17 calculates a planned number of workers using the number of workers decision table created in the number of workers decision table. Determination unit 18 refers to the result in number of workers calculating unit 17 to determine whether the number of that workers in the operation group which have the skill to carry out the operation process satisfies the planned number of workers.

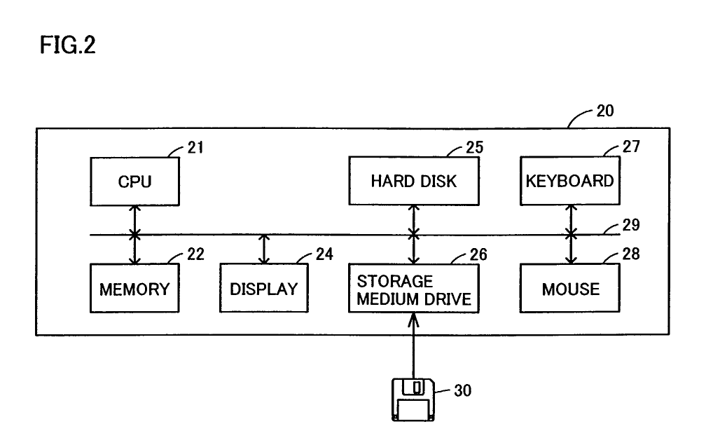

FIG. 2 is a schematic block diagram showing a configuration of a computer.

A computer includes for example a personal computer. Referring to FIG. 2, a computer 20 includes a CPU 21, memory 22, a display 24 a hard disk 25, a recording medium drive 26, a keyboard 27, and a mouse 28.

Memory 22 and hard disk 25 function as memory, keyboard 27 and mouse 28 function as an input device, and display 24 functions as an output device. They are connected to each other through bus 29.

A recording medium 30 is a computer readable storage medium into which the workforce planning program is stored in advance. When recording medium 30 is inserted into recording medium drive 26 and the workforce planning program is installed in hard disk 25, computer 20 functions as workforce planning apparatus 1.

In this embodiment, master file 10 in FIG. 1 corresponds to memory 22 and hard disk 25 in FIG. 2, and number of workers decision table creating unit 16, number of workers calculating unit 17 and determination unit 18 in FIG. 1 correspond to CPU 21 in FIG. 2. It is noted that storage medium 30 as used here includes, a CD-ROM, a magneto-optical (MO) disk, a floppy (R) disk, and the like. Furthermore, an operation system (OS) for causing the workforce planning program operable is installed in hard disk in advance.

An operation of workforce planning apparatus 1 having the configuration described above will be described.

[Operation of Workforce Planning Apparatus]

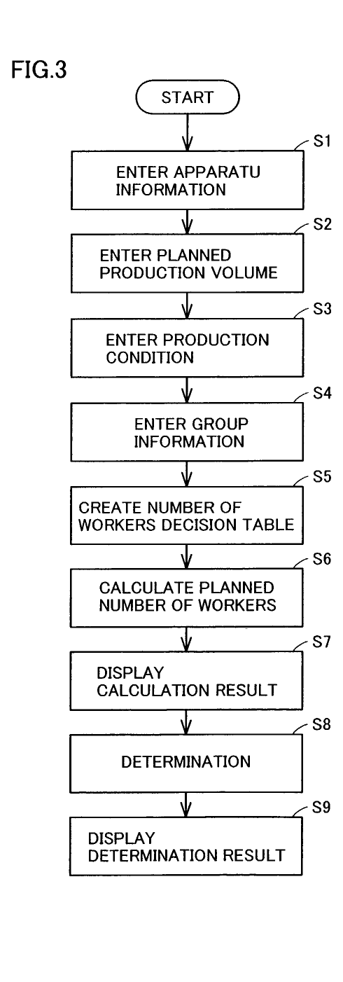

FIG. 3 is a flow chart illustrating an operation of workforce planning apparatus in the embodiment of the present invention.

Referring to FIG. 3, if there is a change in information within operation apparatus information storing file 11, the user of workforce planning apparatus 1 first enters that information (step S1). For entering, keyboard 27 or mouse 28 is used. When the running number of apparatus name AA1 in the table shown in Table 1 is changed from three to four, for example, the value in the running number field corresponding to apparatus name AA1 should be changed from three to four. Furthermore, when a new apparatus DD1 is introduced in the factory, the installation number, the running number, the capacity for apparatus name DD1 are entered. If there is no change in the operation apparatus information, the next step will follow.

Then, if there is a change in information within planned production volume storing file 12, that information is entered (step S2). This change occurs, for example, when it is found that a production volume is increased from a production volume as originally planned in a short period of time. If there is no change in the planned production volume, the next step will follow.

Then, if there is a change in information within production condition storing file 13, that information is entered (step S3). The user enters a new working efficiency value, for example, when the working efficiency changes according to years of statistics. If there is no change in the production condition, the next step will follow.

Then, if there is a change in information within operation group storing file 15, that information is entered (step S4). Referring to Table 4, for example, when it is determined that worker name “HAYASHI” has learned the skill for operation “ΔΔswitch” of the operation process in the small category as a result of a proficiency test periodically conducted in the factory, the user changes “×” to “Δ” in the corresponding field in Table 4. Furthermore, when a new worker participates in an operation group, the user enters information on that worker. If there is no change in operation group information, the next step will follow.

Thereafter, number of workers decision table creating unit 16 in workforce planning apparatus 1 creates the number of workers decision table (step S5).

In Table 6, an exemplary, number of workers decision table is shown.

TABLE 6

| | | operation process details | | | | | | | | | | |
|---|---|---|---|---|---|---|---|---|---|---|---|---|
| | | | | | Small category | | | | | | | planned |
| | | | | | | | operation | | | | | production |
| | | | | | | | time | occurrence | | capacity | working | volume |
| | | | large | medium | | diffi- | (min/ | frequency | running | (lot/ | efficiency | per shift |
| ON | OAN | class | category | category | | culty | process) | (time/shift) | number | running) | (%) | (lot/shift) |
| operation | 300 | variable | production | processing | ◯◯set | B | 11.5 | | 3 | 0.5 | 80 | 5.0 |
| A1 | | | process | | completion | A | 1.0 | | 3 | 0.5 | 80 | 5.0 |
| | | | | | report | | | | | | | |
| | | | | | record | A | 1.0 | | 3 | 0.5 | 80 | 5.0 |
| | | | | carrying | product | C | 2.0 | | 3 | 0.5 | 80 | 5.0 |
| | | | | | carry | | | | | | | |
| | | | | | in process | | | | | | | |
| | | | | | product | D | 2.0 | | 3 | 0.5 | 80 | 5.0 |
| | | | | | carry | | | | | | | |
| | | | | | out of | | | | | | | |
| | | | | | process | | | | | | | |
| | | fixed | setup | changeover | ◯◯ | F | 4.0 | 2 | 3 | 0.5 | 80 | |
| | | | | | exchange | | | | | | | |
| | | | | | ΔΔswitch | G | 3.5 | 1 | 3 | 0.5 | 80 | |
| | | | keep | periodic | ●●check | C | 20.0 | 1 | 3 | 0.5 | 80 | |
| | | | apparatus | inspection | ⋄⋄check | C | 15.0 | 1 | 3 | 0.5 | 80 | |
| | | | running | | □□check | B | 18.0 | 1 | 3 | 0.5 | 80 | |
| | | | | periodic | ΔΔ | G | 40.0 | 0.1 | 3 | 0.5 | 80 | |
| | | | | maintenance | exchange | | | | | | | |
| | | | | | ⋄⋄ | F | 20.0 | 0.1 | 3 | 0.5 | 80 | |
| | | | | | exchange | | | | | | | |
| | | | | | □□ | F | 20.0 | 0.1 | 3 | 0.5 | 80 | |
| | | | | | exchange | | | | | | | |
| | | | apparatus | repair | ΔΔrepair | G | 50.0 | 0.5 | 3 | 0.5 | 80 | |
| | | | recovery | | ⋄⋄repair | G | 60.0 | 0.5 | 3 | 0.5 | 80 | |
| | | | | | ●●repair | H | 60.0 | 0.5 | 3 | 0.5 | 80 | |

Referring to Table 6, the number of workers decision table includes an operation name field, an operation apparatus name field and an operation process details field. These contents are the same as in the table stored in operation group storing file 15 as shown in Table 4 and therefore description thereof will not be repeated.

The number of workers decision table further includes a running number field, a capacity field, a working efficiency field, and a planned production volume per shift field.

The running number and capacity information for the apparatus name recorded in the operation apparatus name field in the number of workers decision table is read from operation apparatus information storing file 11 and recorded in the running number and capacity fields. In this example, the running number “three” for the operation apparatus name “AA1” is recorded in the running number field and the capacity “0.5” lot/running is recorded in the capacity field.

Working efficiency information recorded in production condition storing file 13 is read and recorded in the working efficiency filed. In the example, the working efficiency “80” % is recorded in the working efficiency field.

A planned production volume per shift is calculated based on the daily planned production volume (lot/day) recorded in planned production volume storing file 12 and is recorded in the production volume per shift field. Assuming that there are two shifts per day, a planned production volume per shift in December 2001 is calculated according to the following formula with reference to the daily planned production volume (lot/day) in December 2001 in the table shown in Table 2:

planned production volume per shift=planned production volume(lot/day)/2.

Accordingly, “5.0” lots/shift as a planned production volume per shift in December 2001 is recorded in that part of the planned production volume per shift field in Table 6 which corresponds to the variable class in the operation process details field. It is noted that a planned production volume per shift is calculated in number of workers decision table creating unit 16.

Through the operations described above, after number of workers decision table creating unit 16 creates the number of workers decision table, number of workers calculation unit 17 calculates “work-hour” and “man-number” for each operation process in the small category in Table 6 (step S6). As used herein, “work-hour” refers to workload required to carry out an operation process and is represented by (hour/shift), and “man-number” refers to workload per shift required to carry out an operation and is represented by (the number of people/shift). Therefore, a planned number of workers is indicated by man-number.

Work-hour is calculated according to the following formula using the number of workers decision table shown in Table 6:

work-hour=operation time/capacity×working efficiency×planned production volume per shift.

On the other hand, man-number is calculated according to the following formula using work-hour and man-hour=10.5 hours/(shift·person) as stored in production condition storing file 13:

man-number=work-hour/man-hour.

As shown in Table 7, the work-hour and the man-number as calculated by the calculation method described above are displayed in work-hour and man-number fields further provided in the number of workers decision table in Table 6, on display 24 (step S7). It is noted that the table shown in Table 7 is stored in number of workers decision table storing file 14.

TABLE 6

| | | operation process details | | | | | | | | | | | | |
|---|---|---|---|---|---|---|---|---|---|---|---|---|---|---|
| | | | | | small category | | | | | capa- | work- | planned | | |
| | | | | | | | operation | | run- | city | ing | production | work- | man- |
| | | | large | | | | time | occurrence | ning | (lot/ | ef- | volume | hour | number |
| | | | cate- | medium | | diffi- | (min/ | frequency | num- | run- | ficiency | per shift | (hour/ | (person |
| ON | OAN | class | gory | category | | culty | process) | (time/shift) | ber | ning) | (%) | (lot/shift) | shift) | shift) |
| op- | 300 | var- | production | processing | ◯◯set | B | 11.5 | | 3 | 0.5 | 80 | 5.0 | 1.5 | 0.15 |
| era- | | iable | process | | completion | A | 1.0 | | 3 | 0.5 | 80 | 5.0 | 0.1 | 0.01 |
| tion | | | | | report | | | | | | | | | |
| A1 | | | | | record | A | 1.0 | | 3 | 0.5 | 80 | 5.0 | 0.1 | 0.01 |
| | | | | carrying | product | C | 2.0 | | 3 | 0.5 | 80 | 5.0 | 0.3 | 0.03 |
| | | | | | carry | | | | | | | | | |
| | | | | | in process | | | | | | | | | |
| | | | | | product | D | 2.0 | | 3 | 0.5 | 80 | 5.0 | 0.3 | 0.03 |
| | | | | | carry | | | | | | | | | |
| | | | | | out of | | | | | | | | | |
| | | | | | process | | | | | | | | | |
| | | fixed | setup | changeover | ◯◯ | F | 4.0 | 2 | 3 | 0.5 | 80 | | 0.32 | 0.03 |
| | | | | | exchange | | | | | | | | | |
| | | | | | ΔΔswitch | G | 3.5 | 1 | 3 | 0.5 | 80 | | 0.14 | 0.01 |
| | | | keep | periodic | ●●check | C | 20.0 | 1 | 3 | 0.5 | 80 | | 0.8 | 0.08 |
| | | | apparatus | inspection | ⋄⋄check | C | 15.0 | 1 | 3 | 0.5 | 80 | | 0.6 | 0.06 |
| | | | running | | □□check | B | 18.0 | 1 | 3 | 0.5 | 80 | | 0.72 | 0.07 |
| | | | | periodic | ΔΔ | G | 40.0 | 0.1 | 3 | 0.5 | 80 | | 0.16 | 0.02 |
| | | | | maintenance | exchange | | | | | | | | | |
| | | | | | ⋄⋄ | F | 20.0 | 0.1 | 3 | 0.5 | 80 | | 0.08 | 0.01 |
| | | | | | exchange | | | | | | | | | |
| | | | | | □□ | F | 20.0 | 0.1 | 3 | 0.5 | 80 | | 0.8 | 0.01 |
| | | | | | exchange | | | | | | | | | |
| | | | apparatus | repair | ΔΔrepair | G | 50.0 | 0.5 | 3 | 0.5 | 80 | | 1 | 0.10 |
| | | | recovery | | ⋄⋄repair | G | 60.0 | 0.5 | 3 | 0.5 | 80 | | 1.2 | 0.11 |
| | | | | | ●●repair | H | 60.0 | 0.5 | 3 | 0.5 | 80 | | 1.2 | 0.11 |

Through the operation described above, workforce planning apparatus 1 calculates man-number for each operation process. Therefore, even in a factory having a job shop line in which the number and order of operations are varied, workforce to be allocated can be predicted accurately.

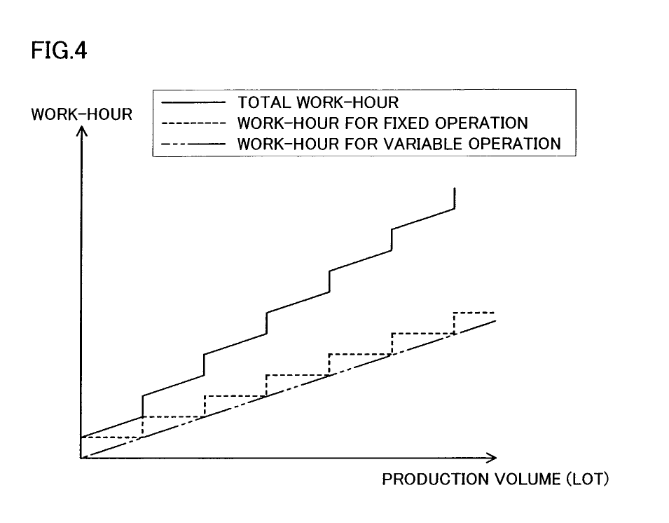

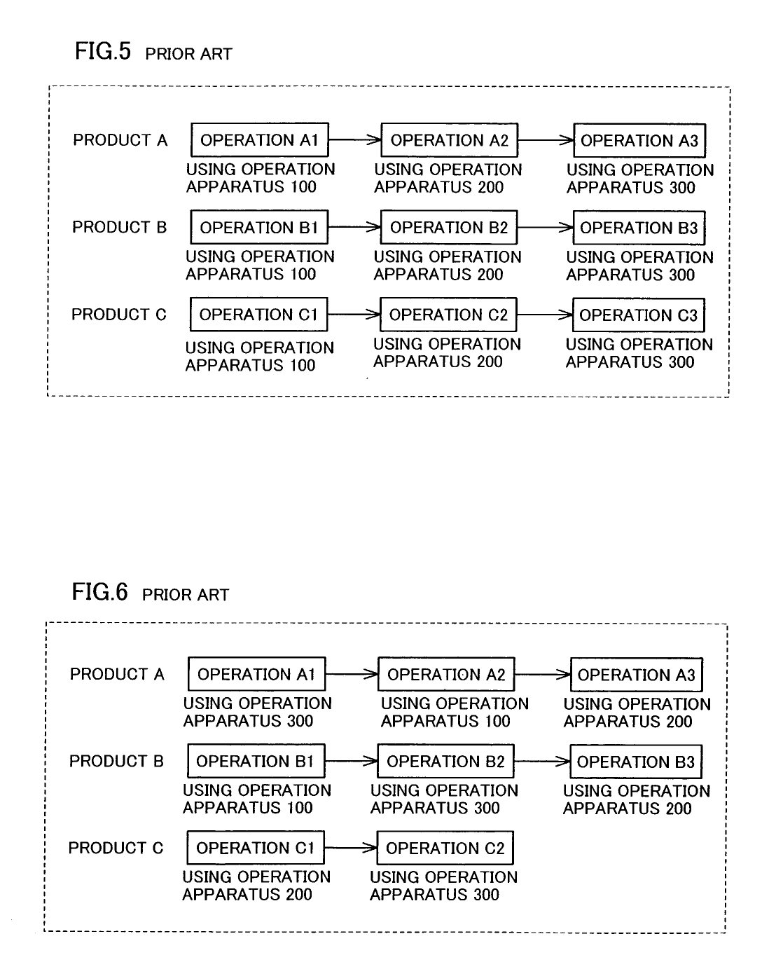

In addition, workforce planning apparatus 1 classifies operation processes into variable and fixed operations. Therefore, the accuracy of calculated values of work-hour is higher than that of the conventional production control. The relation between the production volume and the total work-hour in factory calculated by workforce planning apparatus 1 of the present invention is as shown in FIG. 4. Specifically, while work-hour for variable operation is increased in proportion to increase in production volume, as in the conventional example, work-hour for fixed operation is increased according to the running number of the operation apparatus in the factory. Therefore, the total work-hour that is the sum of the work-hours of variable and fixed operations is increased in a staircase pattern with respect to increase in production volume.

Thereafter, workforce planning apparatus 1 compares the man-number calculated in step S7 with the workers constituting each group to determine if each group can satisfy the number of workers equal to or more than the man-number for each operation process (step S8). This determination is performed in determination unit 18.

Determination unit 18 creates a determination table shown in Table 8.

TABLE 8

| | | | | | | | | first group determination | | | | | | second group determination | | | | | |
|---|---|---|---|---|---|---|---|---|---|---|---|---|---|---|---|---|---|---|---|
| | | operation process details | | | | | | main | | main + | | | | main | | main + | | | |
| | | | large | medium | small category | | man-number | person | | sub | | total | | person | | sub | | total | |
| ON | OAN | class | category | category | | difficulty | (person/shift) | P | D | P | D | P | D | P | D | P | D | P | D |
| opera- | AA1 | variable | production | processing | ◯◯set | B | 0.15 | 1 | ◯ | 2 | ◯ | 6 | ◯ | . | . | . | . | . | . |
| tion | | | process | | completion | A | 0.01 | 1 | ◯ | 2 | ◯ | 6 | ◯ | . | . | . | . | . | . |
| A1 | | | | | report | | | | | | | | | | | | | | |
| | | | | | record | A | 0.01 | 1 | ◯ | 2 | ◯ | 4 | ◯ | . | . | . | . | . | . |
| | | | | carrying | product | C | 0.03 | 1 | ◯ | 2 | ◯ | 4 | ◯ | . | . | . | . | . | . |
| | | | | | carry | | | | | | | | | | | | | | |
| | | | | | in process | | | | | | | | | | | | | | |
| | | | | | product | D | 0.03 | 1 | ◯ | 2 | ◯ | 3 | ◯ | . | . | . | . | . | . |
| | | | | | carry | | | | | | | | | | | | | | |
| | | | | | out of | | | | | | | | | | | | | | |
| | | | | | process | | | | | | | | | | | | | | |
| | | fixed | setup | changeover | ◯◯ | F | 0.03 | 1 | ◯ | 2 | ◯ | 4 | ◯ | . | . | . | . | . | . |
| | | | | | exchange | | | | | | | | | | | | | | |
| | | | | | ΔΔswitch | G | 0.01 | 1 | ◯ | 1 | ◯ | 6 | ◯ | . | . | . | . | . | . |
| | | | keep | periodic | ●●check | C | 0.08 | 1 | ◯ | 2 | ◯ | 4 | ◯ | . | . | . | . | . | . |
| | | | apparatus | inspection | ⋄⋄check | C | 0.06 | 1 | ◯ | 2 | ◯ | 4 | ◯ | . | . | . | . | . | . |
| | | | running | | □□check | B | 0.07 | 1 | ◯ | 2 | ◯ | 5 | ◯ | . | . | . | . | . | . |
| | | | | periodic | ΔΔ | G | 0.02 | 1 | ◯ | 1 | ◯ | 1 | ◯ | . | . | . | . | . | . |
| | | | | maintenance | exchange | | | | | | | | | | | | | | |
| | | | | | ⋄⋄ | F | 0.01 | 1 | ◯ | 2 | ◯ | 2 | ◯ | . | . | . | . | . | . |
| | | | | | exchange | | | | | | | | | | | | | | |
| | | | | | □□ | F | 0.01 | 1 | ◯ | 2 | ◯ | 2 | ◯ | . | . | . | . | . | . |
| | | | apparatus | repair | ΔΔrepair | G | 0.10 | 1 | ◯ | 1 | ◯ | 1 | ◯ | . | . | . | . | . | . |
| | | | recovery | | ⋄⋄repair | G | 0.11 | 1 | ◯ | 1 | ◯ | 1 | ◯ | . | . | . | . | . | . |
| | | | | | ●●repair | H | 0.11 | 0 | X | 0 | X | 1 | ◯ | . | . | . | . | . | . |

Referring to Table 8, the determination table includes an operation name field, an operation apparatus name field, an operation process details field, a man-number field and an each group determination field.

The contents indicated in the operation name, operation apparatus name, operation process details and man-number fields are the same as in Table 7, except that the operation time field and the frequency of occurrence field in the small category field are omitted in the operation process details field in Table 8.

The each group determination field indicates a determination result of whether the number of workers in each group satisfies the man-number.

A first group determination field includes a main person field, a main+sub-persons field and a total field, each further including a number of people (P) field and a determination (D) field.

The main person field indicates the total number of main persons and the determination result for each group in each operation process. The total number of main persons is calculated from the table shown in Table 4 stored in operation group storing file 15 in workforce planning apparatus 1. Furthermore, the number of people field and the man-number field are compared and if the number in the number of people field is greater than that in the man-number field, “◯” as satisfying the man-number, or if smaller, “×” as not satisfying the man-number, is input into the determination field.

In Table 8, in the main person field of the first group, the number of people field for ●●repair operation process shows “0”, and therefore the corresponding determination field indicates “×”. In the main+sub-persons field, the total number of people satisfying skill for each operation process and the determination result are indicated with respect to a main person and a sub-person. In the total field, the total number of people satisfying skill for each operation process and the determination result are indicated with respect to the entire first group. In Table 8, for the total field of the first group, the number of people field in ●●repair operation process shows “1”, and therefore the corresponding determination field indicates “◯”.

In a second group determination field, a similar method as in the first group determination field is used to make a determination. This is applicable to the groups after the second group.

Finally, workforce planning apparatus 1 displays the determination table shown in Table 8 on display 24 after completion of determination in determination unit 18 (step S9). It is noted that the determination table in Table 8 is stored in number of workers decision table storing file 14.

Through the operation described above, it is possible to determine whether the workers constituting each group can carry out an operation process, using the calculated man-number. Therefore, it is possible for the user to determine immediately whether to supply a worker, and also to determine which skill level of worker to be supplied in case that a worker should be supplied.

The above-described workforce planning apparatus is implemented by a program for attaining the function of the workforce planning processing.

The present invention may include the program itself or a computer-readable storage medium storing the same.

In the present invention, the storage medium may be a memory (not shown), such as an ROM itself, necessary for processing in a workforce planning apparatus in FIG. 1. Alternatively, it may be implemented as a readable storage device, by providing a program-reading device (not shown) outside the workforce planning apparatus and inserting therein a storage medium. In either case, the program being stored may be accessed and executed by the workforce planning apparatus; or in either case, the program may be read and the read program may be loaded to a program storage area (not shown) of the workforce planning apparatus and then executed. The program for loading is assumed to be stored in advance in the workforce planning apparatus.

Here, the above storage medium is adapted to be separable from the workforce planning apparatus. The storage medium may be a storage medium including tape-type such as a magnetic tape and a cassette tape; disk-type such as a magnetic disk including a floppy (R) disk, a hard disk and the like as well as an optical disk including a CD-ROM, an MO, an MD, a DVD and the like; card-type such as an IC card, a memory card, an optical card and the like; or a semiconductor memory such as a mask ROM, an EPROM, an EEPROM, a flash ROM and the like.

In addition, the present invention includes a system having a configuration connectable to a network such as the Internet, and thus, may include a storage medium downloading and storing a program from the network. When downloading the program from the network in such a manner, the program for downloading may be pre-installed in the workforce planning apparatus, or may be installed from another storage medium.

Contents stored in the storage medium may include data, not limited to a program.

The present invention may be processing itself as a program executed in the workforce planning apparatus shown in FIG. 1. The program may be taken in, or may have been taken in, or may be sent out, by accessing a network including the Internet. In addition, the program may be a result of processing, that is, produced in the workforce planning 1 apparatus based on the taken-in program. Alternatively, it may be a result of processing, that is, produced in the workforce planning apparatus when being sent out.

In this manner, the present invention may not be limited to a program but include data.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A workforce planning apparatus comprising:
an available apparatus information storing unit storing information on a plurality of apparatuses in use for each of operation processes;
a planned production volume storing unit storing a planned production volume for a prescribed period;
a production condition storing unit storing a production condition through said operation processes;
a number of workers decision table creating unit extracting information from said available apparatus information storing unit, said planned production volume storing unit and said production condition storing unit and recording said extracted information into a number of workers decision table; and
a number of workers calculating unit calculating a planned number of workers to be allocated for each of operation processes using information within said number of workers decision table.

2. The workforce planning apparatus according to claim 1, wherein said number of workers decision table creating unit associates said each of operation processes with said extracted information for recordation in said number of workers decision table.

3. The workforce planning apparatus according to claim 2, further comprising:
an operation group storing unit storing information on a plurality of operation groups including a plurality of workers who work in shifts in a prescribed plurality of operation processes of said operation processes; and
a determination unit comparing said planned number of workers calculated by said number of workers calculating unit with information in said operation group storing unit and determining whether the number of said workers in said operation group satisfies said planned number of workers.

4. The workforce planning apparatus according to claim 3, wherein
said operation group storing unit stores information on whether each of said workers in said operation group has skill to be able to carry out an operation of said each of operation processes, and
said determination unit compares said planned number of workers calculated by said number of workers calculating unit with information in said operation group storing unit and determines whether the number of said workers in said operation group which have skill to be able to carry out said each of operation processes satisfies said planned number of workers.
